(19) United States
(12) Patent Application Publication
(10) Pub. No.: US 2022/0352701 A1
(43) Pub. Date: Nov. 3, 2022

(54) METHOD OF MANUFACTURING WIRING MEMBER-EQUIPPED ADHEREND AND WIRING MEMBER-EQUIPPED ADHEREND

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Hirotaka KATO, Mie (JP); Hiroki HIRAI, Mie (JP); Makoto HIGASHIKOZONO, Mie (JP); Kosuke SONE, Mie (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 17/761,471

(22) PCT Filed: Aug. 6, 2020
(86) PCT No.: PCT/JP2020/030162

§ 371 Date: Mar. 17, 2022

(30) Foreign Application Priority Data
Sep. 30, 2019 (JP) 2019-178906

(51) Int. Cl. H02G 3/30; H05B 6/10; H01B 7/40

(52) U.S. Cl. CPC H02G 3/30; H05B 6/104; H01B 7/40

(57) ABSTRACT

A method of manufacturing a wiring member equipped-adherend includes: a step (a) providing at least one heat generation body generating heat by induction heating between a wiring member including at least one wire-like transmission member and a fixation surface of an adherend; a step (b) providing a magnetic field generation source on a side of the adherend with respect to the wiring member; a step (c) generating a magnetic field fluctuating by the magnetic field generation source; a step (d) making the heat generation body generate heat by induction heating caused by the magnetic field fluctuating by the magnetic field generation source; and a step (e) fixing the wiring member to the fixation surface of the adherend by heat generation in the heat generation body.

### TECHNICAL FIELD

The present disclosure relates to a method of manufacturing a wiring member-equipped adherend.

### BACKGROUND ART

Patent Document 1 discloses a wire harness fixing structure in which a double-sided adhesive tape is attached to a back surface of a molded ceiling and a wire harness is attached on the double-sided adhesive tape.

### PRIOR ART DOCUMENTS

### Patent Documents

Patent Document 1: Japanese Patent Application Laid-Open No. 2000-264137

### SUMMARY

### Problem to be Solved by the Invention

However, according to the technique disclosed in Patent Document 1, an operation of attaching the double-sided adhesive tape to the molded ceiling is necessary. Thus, an operation of attaching a wire harness to a molded ceiling is troublesome.

Thus, proposed is a configuration that a heat generation layer generating heat by an electromagnetic wave and a melt layer melted by the heat of the heat generation layer are provided between an electrical wire and an adherend. In this case, it is desired that a part of the melt layer necessary for fixing the electrical wire and the adherend is effectively melted.

Thus, an object is to enable effective heating for fixation in fixing a wiring member and an adherend by induction heating.

### Means to Solve the Problem

A method of manufacturing a wiring member equipped-adherend according to the present disclosure is a method of manufacturing a wiring member equipped-adherend including: a step (a) providing at least one heat generation body generating heat by induction heating between a wiring member including at least one wire-like transmission member and a fixation surface of an adherend; a step (b) providing a magnetic field generation source on a side of the adherend with respect to the wiring member; a step (c) generating a magnetic field fluctuating by the magnetic field generation source; a step (d) making the heat generation body generate heat by induction heating caused by the magnetic field fluctuating by the magnetic field generation source; and a step (e) fixing the wiring member to the fixation surface of the adherend by heat generation in the heat generation body.

### Effects of the Invention

According to the present disclosure, heating for fixation can be effectively performed in fixing a wiring member and an adherend by induction heating.

### BRIEF DESCRIPTION OF DRAWINGS

FIG. 1 is a schematic perspective view illustrating a wiring member-equipped adherend according to an embodiment.

FIG. 2 is an explanation view illustrating an example of a step (a).

FIG. 3 is an explanation view illustrating an example of a step (b).

FIG. 4 is an explanation view illustrating an example of steps (c) and (d).

FIG. 5 is an explanation view illustrating an example of a step (e).

FIG. 6 is an explanation view illustrating an example of attaching a heat generation body to a wiring member.

FIG. 7 is an explanation view illustrating an example of placing a joint layer.

FIG. 8 is an explanation view illustrating an example of placing a heat generation body.

FIG. 9 is an explanation view illustrating an example of partially providing the heat generation body on the wiring member.

### DESCRIPTION OF EMBODIMENT(S)

### Description of Embodiment of Present Disclosure

Embodiments of the present disclosure are listed and described firstly.

A wiring member-equipped adherend according to the present disclosure is as follows.

(1) A method of manufacturing a wiring member equipped-adherend includes: a step (a) providing at least one heat generation body generating heat by induction heating between a wiring member including at least one wire-like transmission member and a fixation surface of an adherend; a step (b) providing a magnetic field generation source on a side of the adherend with respect to the wiring member; a step (c) generating a magnetic field fluctuating by the magnetic field generation source; a step (d) making the heat generation body generate heat by induction heating caused by the magnetic field fluctuating by the magnetic field generation source; and a step (e) fixing the wiring member to the fixation surface of the adherend by heat generation in the heat generation body.

According to the present manufacturing method, the heat generation body effectively generates heat between the wiring member and the fixation surface of the adherend. Accordingly, heating for fixation can be effectively performed in fixing the wiring member and the adherend by induction heating.

(2) The heat generation body may surround a periphery of the wiring member in the step (a). In this case, the heat generation body needs not be provided on a side of the adherend previously. The heat generation body intervenes between the wiring member and the adherend whichever part of an outer periphery of the wiring member is directed to the side of the fixation surface, thus an operation of placing the wiring member is easily performed.

(3) In the step (a), the heat generation body may cover the fixation surface. In this case, the heat generation body needs not be attached to the wiring member previously. The heat generation body intervenes between the wiring member and the adherend whichever part of an outer periphery of the wiring member is directed to the side of the fixation surface, thus an operation of placing the wiring member is easily performed.

(4) In the step (a), a joint layer having joint properties when heat is applied may intervene in at least one of a region between the heat generation body and the wiring member and a region between the heat generation body and the adherend. In this case, the joint layer has the joint properties when the heat is applied, and the wiring member is fixed to the adherend.

(5) In the step (a), the plurality of heat generation bodies may be partially provided at intervals in an extension direction of the wiring member. In this case, it is preferable that the fixation operation using the fluctuating magnetic field is not performed in the whole region but is performed at a plurality of positions at intervals in the extension direction of the wiring member. Thus, the wiring member can be easily fixed to the adherend.

### Details of Embodiment of Present Disclosure

Specific examples of a method of manufacturing a wiring member-equipped adherend according to the present disclosure are described hereinafter with reference to the drawings. The present disclosure is not limited to these examples, but is indicated by claims, and it is intended that meanings equivalent to claims and all modifications within a scope of claims are included.

### Embodiment

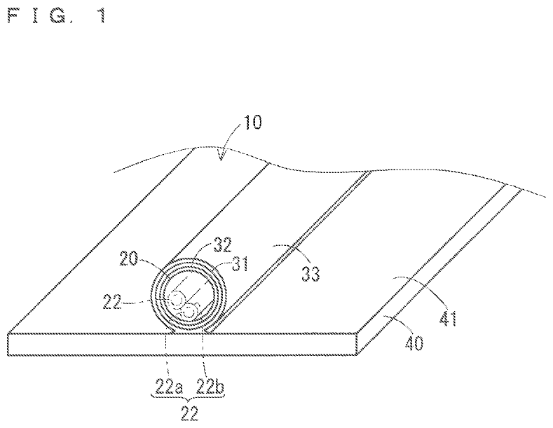

A method of manufacturing a wiring member-equipped adherend according to an embodiment is described hereinafter. FIG. 1 is a schematic perspective view illustrating a wiring member-equipped adherend 10 manufactured by a method of manufacturing a wiring member-equipped adherend according to an embodiment.

The wiring member-equipped adherend 10 includes a wiring member 20 and an adherend 40. The wiring member 20 is fixed to the adherend 40.

The wiring member 20 includes at least one wire-like transmission member 22 (some wire-like transmission members are illustrated in FIG. 1). The wire-like transmission member 22 may be a wire-like member transmitting an electrical power or light, for example. For example, the wire-like transmission member 22 may be a general wire having a core wire 22a and a covering 22b around the core wire, or may also be a bare wire, a shielded wire, a twisted wire, an enamel wire, a nichrome wire, or an optical fiber.

The wire-like transmission member transmitting the electrical power may be various kinds of signal lines or various kinds of power lines. The wire-like transmission member transmitting the electrical power may be used as an antenna or coil, for example, transmitting or receiving a signal or an electrical power to or from a space.

The wire-like transmission member may be a. single wire-like object or a composite object of a plurality of wire-like objects (a twisted wire and a cable made up of a plurality of wire-like objects covered by a sheath).

In an example described herein, the wiring member 20 is a bundle of a plurality of wire-like transmission members 22. In an example described herein, the wire-like transmission member 22 is an electrical wire. The wiring member may include only one wire-like transmission member 22. The wiring member may be made up of a plurality or electrical wire collected in a flat form. The wiring member may be flexible printed circuits (FPC) or a flexible fat cable including a conductor as at least one wire-like transmission member.

The adherend 40 includes a fixation surface 41. The fixation surface 41 may be a planar surface or a curved surface. Described herein s a case where the adherend 40 includes a flat plate-like part and one main surface of the plate-like part is the fixation surface 41. The adherend 40 is assumed to be an interior member in a vehicle such as a roof trim or a door trim, and particularly a panel-like member made of resin. A material of the adherend 40 is not particularly limited as long as a magnetic flux can pass through the material, however, the adherend 40 is preferably formed by a material which does not absorb the magnetic flux as much as possible, thus iron, for example, is not applied.

The wiring member 20 is fixed to the adherend 40, thus the wiring member-equipped adherend 10 is manufactured. In the present example, a heat generation body 31 intervenes between the wiring member 20 and the adherend 40. The heat generation body 31 is a part generating heat by induction heating. The heat generation body 31 may be a conductor, for example, and is made up of a material easily heated by induction heating such as metal (aluminum, copper, iron, or alloy thereof). The heat generation body 31 preferably has a shape extending to an extent that a joint layer described hereinafter can be heated to a temperature high enough to have joint properties by induction heating. The heat generation body 31 may be a metal foil. Particularly, based on an assumption that the wire-like transmission member 22 is the electrical wire, when the heat generation body 31 is a member extending wider than a diameter of a strand constituting the core wire, the heat generation body 31 can effectively generate heat while heat generation in the core wire is suppressed.

A wiring member side layer 32 intervenes between the heat generation body 31 and the wiring member 20. An adherend side layer 33 intervenes between the heat generation body 31 and the adherend 40. At least one of the wiring member side layer 32 and the adherend side layer 33 may be a joint layer having joint properties when heat is applied. Thermoplastic resin is assumed to be an example of the joint layer having the joint properties when the heat is applied. In this case, the joint layer is assumed to be softened or melted by heating and joined to a part having contact with the joint layer. Thermoplastic resin may be the joint layer having the joint properties when the heat is applied. In this case, it is assumed that the joint layer having viscosity high enough to he kept in contact with the heat generation body 31 is hardened by heat while having contact with the other part and joined to the part having contact with the joint layer.

Described herein is an example that the adherend side layer 33 on a side of an outer periphery of the heat generation body 31 is the joint layer. Both the wiring member side layer 32 and the adherend side layer 33 may be joint layers.

One of the wiring member side layer 32 and the adherend side layer 33 may be an pressure-sensitive adhesive layer. The pressure-sensitive adhesive layer is a part adhering by being pressed against a target member. Described herein is an example that the wiring member side layer 32 on a side of an inner periphery of the heat generation body 31 is the pressure-sensitive adhesive layer.

In the example illustrated in FIG. 1, the heat generation body 31, the wiring member side layer 32, and the adherend side layer 33 are provided to surround a periphery of the wiring member 20. The heat generation body 31 adheres to an outer side part of the wiring member 20 by the wiring member side layer 32 as the pressure-sensitive adhesive layer. The heat generation body 31 is joined to the adherend 40 via the adherend side layer 33 as the joint layer between the heat generation body 31 and the adherend. Accordingly, the wiring member 20 is fixed to the adherend 40. Described hereinafter is a method of manufacturing the wiring member-equipped adherend 10.

A method of manufacturing the wiring member equipped-adherend 10 includes: a step (a) providing at least one heat generation body 31 generating heat by induction heating between the wiring member 20 including at least one wire-like transmission member 22 and the fixation surface 41 of the adherend 40; a step (b) providing a magnetic field generation source 52 on a side of the adherend 40 with respect to the wiring member 20; a step (c) generating a magnetic field (alternating magnetic field) fluctuating by the magnetic field generation source 52; a step (d) making the heat generation body 31 generate heat by induction heating caused by the magnetic field fluctuating by the magnetic field generation source 52; and a step (d) fixing the wiring member 20 to the fixation surface 41 of the adherend 40 by heat generation in the heat generation body 31.

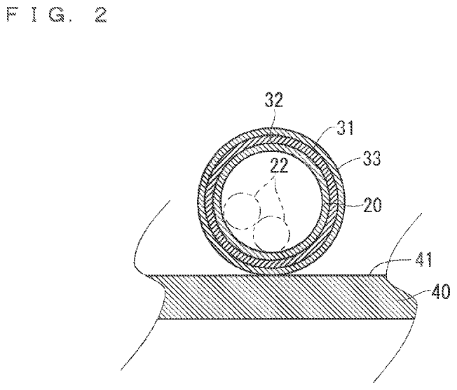

FIG. 2 is an explanation view illustrating an example of the step (a). Herein, prepared in the step (a) is the heat generation body 31, the wiring member side layer 32, and the adherend side layer 33 described above provided around the wiring member 20. The wiring member 20 is disposed on the fixation surface 41 of the adherend 40.

The heat generation body 31 is provided to surround the periphery of the wiring member 20, thus the heat generation body needs not be provided on the adherend 40. The heat generation body 31 is provided to surround the periphery of the wiring member 20, thus any position of an outer peripheral part of the wiring member 20 may have contact with the adherend 40.

In the step (a), the wiring member side layer 32 as the pressure-sensitive adhesive layer is located between the heat generation body 31 and the wiring member 20. The wiring member side layer 32 as the pressure-sensitive adhesive layer keeps the heat generation body 31 fixed to the wiring member 20 before heating by the heat generation body 31. The heat generation body 31 and the wiring member side layer 32 as the pressure-sensitive adhesive layer are wound by the wiring member 20, thus the heat generation body 31 is kept in a state of being fixed to the wiring member 20 more reliably. The wiring member side layer 32 located between the heat generation body 31 and the wiring member 20 may be a joint layer.

In the step (a), the adherend side layer 33 as the joint layer is located between the heat generation body 31 and the adherend 40. The adherend side layer 33 as the joint layer is provided to surround the periphery of the wiring member 20. In other words, the adherend side layer 33 as the joint layer is provided on a whole outer side surface of the heat generation body 31 provided to surround the periphery of the wiring member 20. The adherend side layer 33 is located on the whole outer periphery of the wiring member 20, thus any position of an outer peripheral part of the wiring member 20 may have contact with the adherend 40. The adherend side layer 33 may be an pressure-sensitive adhesive layer.

The wiring member side layer 32, the heat generation body 31, and the adherend side layer 33 may be located only on a part of the outer peripheral part of the wiring member 20.

The heat generation body 31 is wound around the wiring member 20, thus when the wiring member 20 is placed on the fixation surface 41 of the adherend 40, the heat generation body 31 is provided between the wiring member 20 and the fixation surface 41.

The adherend side layer 33 as the joint layer is provided on the outer periphery of the heat generation body 31, thus when the wiring member 20 is placed on the fixation surface 41 of the adherend 40, the adherend side layer 33 as the joint layer intervenes between the heat generation body 31 and the adherend 40.

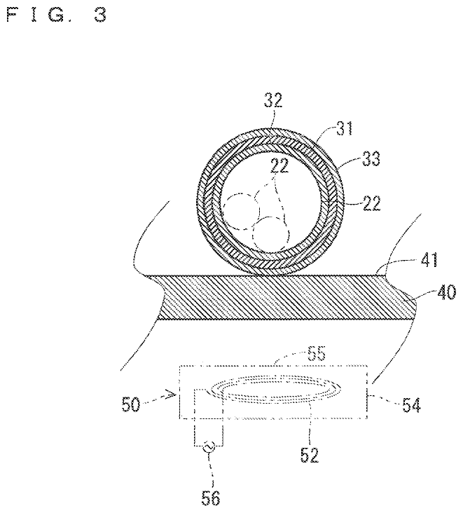

FIG. 3 is an explanation view illustrating an example of the step (b). In the step (b), the magnetic field generation source 52 is provided on a side of the adherend 40 with respect to the wiring member 20.

That is to say, an induction heating apparatus 50 includes the magnetic field generation source 52, a body part 54 housing the magnetic field generation source 52, and an alternating current source 56 for flowing alternating current to the magnetic field generation source 52. The magnetic field generation source 52 is a coil. A proximity surface 55 getting close to the other side member is provided on the body part 54. When the alternating current flows in the magnetic field generation source 52 in the induction heating apparatus 50, a magnetic line is generated around the magnetic field generation source 52. The proximity surface 55 is a surface through which a lot of magnetic lines pass. The alternating current source 56 is not particularly limited, but may be made up in accordance with a power source. For example, when the induction heating apparatus 50 uses a commercial power source, the alternating current source 56 is considered to be made up of an electrical transformer reducing voltage of the commercial power source, a rectifier rectifying alternating current to direct current, and a high-frequency generator generating a high frequency from the direct current. A frequency and voltage, for example, are appropriately set in accordance with a material, a shape, and a size of the heat generation body 31.

The proximity surface 55 of the induction heating apparatus 50 is brought close to the adherend 40 from an opposite side of the wiring member 20. That is to say, the proximity surface 55 is disposed to face a surface of the adherend 40 on a side opposite to the fixation surface 41. The proximity surface 55 may be pressed against or separated from the adherend 40. Accordingly, the magnetic field generation source 52 is provided on a side of the adherend 40 with respect to the wiring member 20.

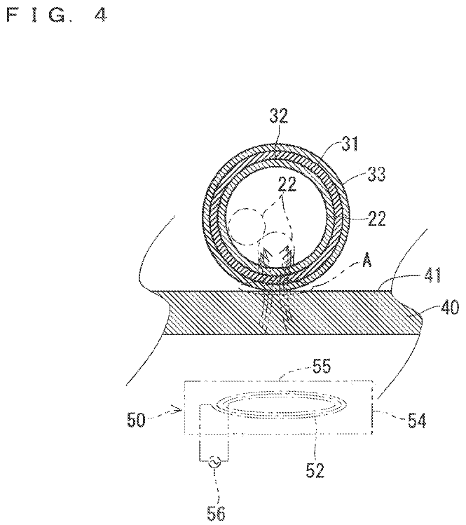

FIG. 4 is an explanation view illustrating an example of the steps (c) and (d). In the step (c), a magnetic field fluctuating by the magnetic field generation source 52 is generated. That is to say, when the alternating current flows in the magnetic field generation source 52 as the coil, a magnetic line (magnetic field) fluctuating depending on a direction and a magnitude of the alternating current is generated around the magnetic field generation source 52. In the step (d), the heat generation body 31 generates heat by induction heating caused by the magnetic line (magnetic field). That is to say, the magnetic line described above passes through the heat generation body 31 via the adherend 40. When the magnetic line passes through the heat generation body 31, eddy current flows in the heat generation body 31. Accordingly, Joule heat is generated in the heat generation body 31 in accordance with an eddy-current loss. Thus, the heat generation body 31 generates heat. At this time, the magnetic field generation source 52 is provided on a side of the adherend 40 with respect to the wiring member 20. Thus, the number of magnetic lines passing through the heat generation body 31 increases as the magnetic line gets closer to the adherend 40. Thus, the heat generation body 31 generates higher temperature heat as the heat generation body 31 gets closer to the adherend 40. Accordingly, a part of the adherend side layer 33 closer to the adherend 40 (refer to an arrow A) is heated to a higher temperature compared with a part thereof located away from the adherend 40.

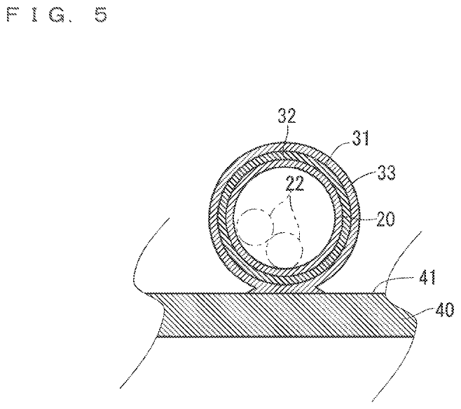

FIG. 5 is an explanation view illustrating an example of the step (e). In the step (e), the wiring member 20 is fixed to the fixation surface 41 of the adherend 40 by the heat generated in the heat generation body 31. That is to say, the adherend side layer 33, particularly the part thereof close to the adherend 40 is heated by the heat generated in the heat generation body 31. Accordingly, the adherend side layer 33 has the joint properties, and is joined to the adherend 40. For example, when the adherend side layer 33 is made of thermoplastic resin, a part of the adherend side layer 33 having contact with the adherend 40 is centrally softened or melted, and joined to the adherend 40.

Subsequently, when the heating by the induction heating apparatus 50 is finished, the softened or melted adherend side layer 33 is cooled, and the joint state described above is maintained.

According to the method of manufacturing the wiring member-equipped adherend 10 having the above configuration, the magnetic field fluctuating by the magnetic field generation source 52 is generated in the state where the magnetic field generation source 52 is provided on the side of the adherend 40 with respect to the wiring member 20. Thus, the heat generation body 31 effectively generates heat between the wiring member 20 and the fixation surface 41 of the adherend 40. Accordingly, heating for fixation can be effectively performed in fixing the wiring member 20 and the adherend 40 by induction heating.

That is to say, a position on the side of the adherend 40 with respect to the wiring meatier 20 and a position on a side opposite to the adherend 40 with respect to the wiring member 20 are assumed to be a position where the magnetic field generation source is disposed to fix the wiring member 20 to the adherend 40 by induction heating. It is assumed that the magnetic field fluctuating by the magnetic field generation source 52 is generated in the state where the magnetic field generation source 52 is provided on the side opposite to the adherend 40 with respect to the wiring member 20. In this case, a part of the heat generation body 31 on the side opposite to the adherend 40 is assumed to be heated the most. Then, it is assumed to take a long time to nick or soften the part of the adherend side layer 33 close to the adherend 40. A part of the wiring member 20, the wiring member side layer 32, and the adherend side layer 33 on the side opposite to the adherend 40 is assumed to be heated more than necessary, and deformed by melting, for example, in some cases.

In contrast, in the present embodiment, the part of the adherend side layer 33 close to the adherend 40 is melted or softened for as short a time as possible, and the fixation is rapidly performed. Suppressed is an excessive heating of a part of the wiring member 20, the wiring member side layer 32, and the adherend side layer 33 on the side opposite to the adherend 40 more than necessary. That is to say, when the wiring member 20, the wiring member side layer 32, and the adherend side layer 33 are observed, a trace of melting or softening remains the most in a part between the wiring member 20 and the adherend 40, and compared with this part, a trace of melting or softening remains less in a part on the side opposite to the adherend 40.

The heat generation body 31 surrounds the periphery of the wiring member 20, thus there is no need to prepare a special configuration with a heat generation body as the adherend 40. When the wiring member 20 is disposed on the fixation surface 41 of the adherend 40, the heat generation body 31 intervenes between the wiring member 20 and the adherend 40 whichever part of the wiring member 20 is directed to the side of the fixation surface 41, thus an operation of placing the wiring member 20 is easily performed.

The joint layer having the joint properties when heat is applied intervenes in at least one of a region between the heat generation body 31 and the wiring member 20 and a region between the heat generation body 31 and the adherend 40. Herein, the adherend side layer 33 as the joint layer intervenes between the heat generation body 31 and the adherend 40. Thus, the adherend side layer 33 as the joint layer has the joint properties when the heat generation body 31 generates heat, and the wiring member 20 is fixed to the adherend 40.

In the present embodiment, the heat generation body 31 is fixed to the wiring member 20 by the wiring member side layer 32 as the pressure-sensitive adhesive layer. Then, the wiring member 20 is fixed to the adherend 40 by the adherend side layer 33 as the joint layer when heat is applied.

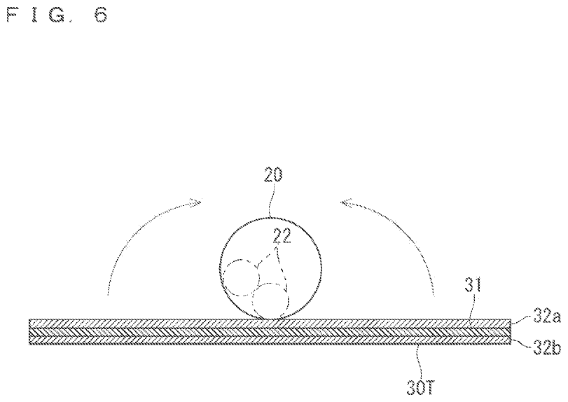

An attachment structure of the heat generation body 31 fixed to the wiring member 20 is not particularly limited. For example, as illustrated in FIG. 6, prepared is a laminated tape 30T made up of an pressure-sensitive adhesive layer 32a formed on one surface of the band-like heat generation body 31 and a joint layer 33b formed on the other surface thereof. When the laminated tape 30T is wound around the wiring member 20, the heat generation body 31 is fixed to the wiring member 20 via the pressure-sensitive adhesive layer 32a. In this case, the pressure-sensitive adhesive layer 32a functions as the wiring member side layer 32 on a side of an inner periphery of the heat generation body 31. The joint layer 33b functions as the adherend side layer 33 on a side of an outer periphery of the heat generation body 31.

When the wiring member 20 includes the plurality of wire-like transmission members 22, the laminated tape 30T can also function as a banding member keeping the plurality of wire-like transmission members 22 in a bundled state.

A winding structure of the laminated tape 30T wound around the wiring member 20 is not particularly limited. The laminated tape 30T may be spirally wound around the wiring member 20. One end portion may cover an outer periphery of the other end portion in a state where the laminated tape 30T is wound around the wiring member 20. The pressure-sensitive adhesive layers 32a in one end portion and the other end portion may adhere to each other in a state where the laminated tape 30T is wound around the wiring member 20.

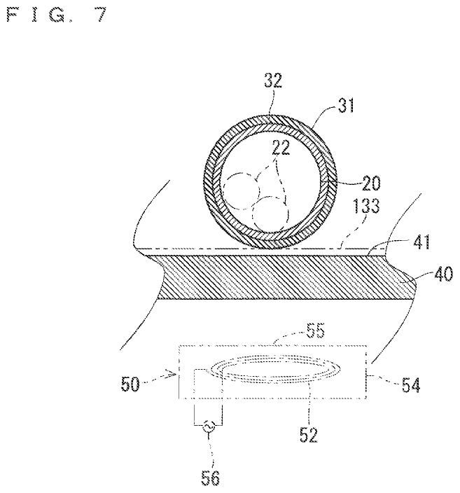

It is not necessary that the adherend side layer 33 as the joint layer is provided on a side of the wiring member 20. For example, as illustrated in FIG. 7, the adherend side layer 33 may be omitted in the embodiment described above. In this case, a joint layer 133 may be provided to cover the fixation surface 41 on the fixation surface 41 of the adherend 40. When the fixation surface 41 of the adherend 40 itself has joint properties of being softened or melted by heat, the joint layer 133 separately provided may be omitted.

It is not necessary that the wiring member side layer 32 as the pressure-sensitive adhesive layer 32a is provided on the wiring member 20. Also applicable is a configuration that the heat generation body 31 is directly welded to or embedded in a covering of the wiring member 20. The heat generation body 31 may be kept in a state of being fixed to the outer periphery of the wiring member 20 by a different adhesive tape, for example.

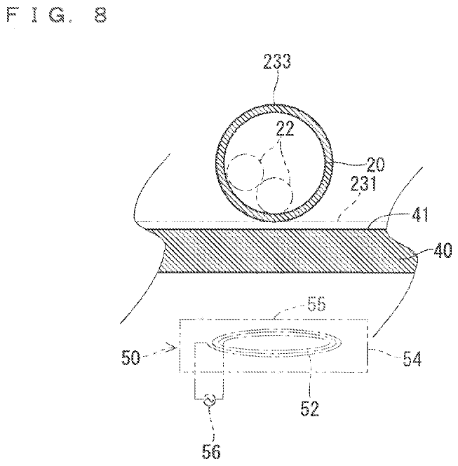

It is not necessary that the heat generation body 31 covers the periphery of the wring member 20. For example, as illustrated in FIG. 8, a heat generation body 231 may cover the fixation surface 41 in the step (a). For example, the heat generation body 231 as a metal boil or a metal plate may be joined to the fixation surface 41 of the adherend 40.

In this case, a joint layer 233 may be provided between the heat generation body 31 and the wiring member 20. Herein, the joint layer 233 is formed to surround the periphery of the wiring member 20. The joint layer 233 is wound around the periphery of the wiring member 20. A winding state of the joint layer 233 may be held by an pressure-sensitive adhesive layer, for example.

Also in the present example, when the fluctuating magnetic field is generated while the magnetic field generation source 52 is provided on the side of the adherend 40 of the wiring member 20, the heat generation body 231 is effectively heated between the wiring member 20 and the adherend 40. Accordingly, the joint layer 233 is effectively softened or melted, and the wiring member 20 and the heat generation body 231 is joined to each other. Accordingly, the wiring member 20 is fixed to the adherend 40.

In the present example, the heat generation body needs not be attached to the wiring member 20 previously. The heat generation body 231 intervenes between the wiring member 20 and the adherend 40 whichever part of an outer periphery of the wiring member 20 is directed to the side of the fixation surface 41, thus the operation of placing the wiring member 20 is easily performed.

When the surface of the wiring member 20 itself is made up of a material having joint properties such as thermoplastic resin, for example, the joint layer 233 needs not be provided separately.

A position where the wiring member 20 is fixed to the adherend 40 may be a whole or part of the wiring member 20 in the extension direction.

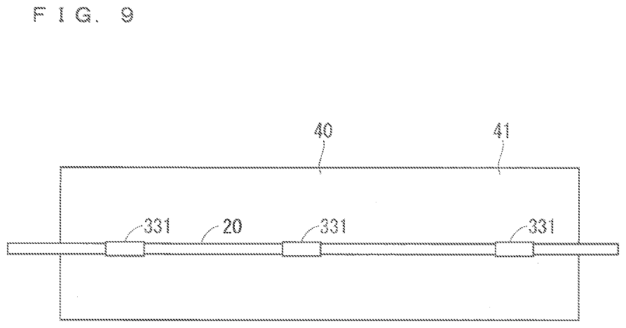

For example, as illustrated in FIG. 9, in the step (a), a plurality of heat generation bodies 331 may be partially provided at intervals on the wiring member 20 in the extension direction. In the manner similar to the above embodiment, a joint layer may be provided on a side of an outer periphery of the heat generation body 331 or the surface of the adherend 40. In this case, it is sufficient that the heat generation body 331 is partially provided on the wiring member 20, thus an operation of attaching the heat generation body 331 to the wiring member 20 is easily performed. It is preferable that the fixation operation using the fluctuating magnetic field is not performed in the whole region but is performed at a plurality of positions at intervals in the extension direction of the wiring member 20. Thus, the wiring member 20 is easily fixed to the adherend 40.

Each configuration described in the embodiment and each modification example can be appropriately combined as long as they are not contradictory.

### EXPLANATION OF REFERENCE SIGNS

10 wiring member-equipped adherend

20 wiring member

22 wire-like transmission member

22a core wire

22b covering

30T laminated tape

31 heat generation body

32 wiring member side layer

32a pressure-sensitive adhesive layer

33 adherend side layer

33b joint layer

40 adherend

41 fixation surface

50 induction heating apparatus

52 magnetic field generation source

54 body part

55 proximity surface

56 alternating current source

133 joint layer

231 heat generation body

233 joint layer

331 heat generation body

1-5. (canceled)

6. A method of manufacturing a wiring member-equipped adherend, comprising:
providing at least one heat generation body generating heat by induction heating between a wiring member including at least one wire-like transmission member and a fixation surface of an adherend;
providing a magnetic field generation source on a side of the adherend with respect to the wiring member;
generating a magnetic field fluctuating by the magnetic field generation source;
making the heat generation body generate heat by induction heating caused by the magnetic field fluctuating by the magnetic field generation source; and
fixing the wiring member to the fixation surface of the adherend by heat generation in the heat generation body, wherein
the heat generation body surrounds a periphery of the wiring member in the providing at least one heat generation body.

7. The method of manufacturing the wiring member-equipped adherend according to claim 6, wherein
in the providing at least one heat generation body, an pressure-sensitive adhesive layer adhering to the wiring member is provided on a side of the wiring member of the heat generation body, and a joint layer having joint properties when heat is applied is provided on an opposite side of the heat generation body from the pressure-sensitive adhesive layer.

8. The method of manufacturing the wiring member-equipped adherend according to claim 6, wherein
in the providing at least one heat generation body, a joint layer having joint properties when heat is applied intervenes in at least one of a region between the heat generation body and the wiring member and a region between the heat generation body and the adherend.

9. The method of manufacturing the wiring member-equipped adherend according to claim 6, wherein
in the providing at least one heat generation body, the plurality of heat generation bodies are partially provided at intervals in an extension direction of the wiring member.

10. A method of manufacturing the wiring member-equipped adherend, comprising:
providing at least one heat generation body generating heat by induction heating between a wiring member including a bundle of a plurality of wire-like transmission members and a fixation surface of an adherend;
providing a magnetic field generation source on a side of the adherend with respect to the wiring member;
generating a magnetic field fluctuating by the magnetic field generation source;
making the heat generation body generate heat by induction heating caused by the magnetic field fluctuating by the magnetic field generation source; and
fixing the wiring member to the fixation surface of the adherend by heat generation in the heat generation body, wherein
in the providing at least one heat generation body, the heat generation body covers the fixation surface.

11. The method of manufacturing the wiring member-equipped adherend according to claim 10, wherein
in the providing at least one heat generation body, a joint layer having joint properties when heat is applied intervenes in at least one of a region between the heat generation body and the wiring member and a region between the heat generation body and the adherend.

12. The method of manufacturing the wiring member-equipped adherend according to claim 10, wherein
in the providing at least one heat generation body, the plurality of heat generation bodies are partially provided at intervals in an extension direction of the wiring member.

13. The method of manufacturing the wiring member-equipped adherend according to claim 10, wherein
the adherend is an interior member in a vehicle.

14. A wiring member-equipped adherend, wherein
at least one heat generation body generating heat by induction heating is provided between a wiring member including at least one wire-like transmission member and a fixation surface of an adherend,
the heat generation body surrounds a periphery of the wiring member, and
the wiring member is fixed to the fixation surface of the adherend by heat generation in the heat generation body.

15. The wiring member-equipped adherend according to claim 14, wherein
a pressure-sensitive adhesive layer adhering to the wiring member is provided on a side of the wiring member with respect to the heat generation body, and a joint layer having joint properties when heat is applied is provided on an opposite side with respect to the heat generation body from the pressure-sensitive adhesive layer.

16. A wiring member-equipped adherend, wherein
at least one heat generation body generating heat by induction heating is provided between a wiring member including a bundle of a plurality of wire-like transmission members and a fixation surface of an adherend,
the heat generation body covers the fixation surface, and
the wiring member is fixed to the fixation surface of the adherend by heat generation in the heat generation body.

17. The wiring member-equipped adherend according to claim 16, wherein
the adherend is an interior member in a vehicle.
